(19) United States
(12) Patent Application Publication
(10) Pub. No.: US 2020/0041855 A1
(43) Pub. Date: Feb. 6, 2020

(54) DISPLAY DEVICE

(71) Applicant: Samsung Display Co., Ltd., Yongin-si (KR)

(72) Inventors: Na Hyeon CHA, Suwon-si (KR); Seong Young LEE, Hwaseong-si (KR); Kyung Ho KIM, Seongnam-si (KR); Hae Jin KIM, Asan-si (KR); Yong Hee LEE, Suwon-si (KR)

(21) Appl. No.: 16/293,643

(22) Filed: Mar. 6, 2019

(30) Foreign Application Priority Data
Aug. 6, 2018 (KR) 10-2018-0091272

(51) Int. Cl. G02F 1/1362

(52) U.S. Cl. CPC G02F 1/136286; G02F 1/136209; G02F 2201/123; G02F 2001/136222; G02F 1/136277

(57) ABSTRACT

A display device includes: a substrate; a first transistor and a second transistor disposed on the substrate; a first sub-pixel electrode electrically connected to a first drain electrode of the first transistor; a second sub-pixel electrode electrically connected to a second drain electrode of the second transistor; and color filter layers disposed between the first and second transistors and the first and second sub-pixel electrodes, the color filter layers including: a first color filter overlapping the first transistor and the first sub-pixel electrode, the first color filter representing a first color, and a first color filter pattern representing a second color different from the first color, the first color filter pattern overlapping the first transistor and the second transistor.

### CROSS-REFERENCE TO RELATED APPLICATION

This application claims priority from and the benefit of Korean Patent Application No. 10-2018-0091272 filed on Aug. 6, 2018, which is hereby incorporated by reference for all purposes as if fully set forth herein.

### BACKGROUND

### Field

Exemplary implementations of the invention relate generally to a display device.

### Discussion of the Background

A display device such as a liquid crystal display (LCD), an organic light emitting diode display, etc. generally includes a display panel including a plurality of pixels as a unit displaying an image.

The display panel of the liquid crystal display includes a liquid crystal layer including a liquid crystal, a field generating electrode for controlling an alignment of the liquid crystal of the liquid crystal layer, a plurality of signal lines for applying a voltage to at least some of field generating electrodes, and a plurality of switching elements connected thereto. If the voltage is applied to the field generating electrodes, an electric field is generated to the liquid crystal layer and the liquid crystal is rearranged, and accordingly, an amount of transmitted light is controlled, thereby displaying a desired image. To control the transmitted light, the display panel may include at least one polarizer.

The field generating electrodes included in the liquid crystal display include a pixel electrode receiving a data voltage and a common electrode receiving a common voltage. The pixel electrode may receive the data voltage through a switching element that may be a transistor.

The above information disclosed in this Background section is only for understanding of the background of the inventive concepts, and, therefore, it may contain information that does not constitute prior art.

### SUMMARY

Devices constructed according to exemplary implementations of the invention are capable of providing a display device for reducing a change of a threshold voltage of the transistor included in the display device, effectively managing uniformity of a size of a pattern, and reducing a defect rate such as a separation of a pattern.

Additional features of the inventive concepts will be set forth in the description which follows, and in part will be apparent from the description, or may be learned by practice of the inventive concepts.

According to one or more embodiments of the invention, a display device includes: a substrate; a first transistor and a second transistor disposed on the substrate; a first sub-pixel electrode electrically connected to a first drain electrode of the first transistor; a second sub-pixel electrode electrically connected to a second drain electrode of the second transistor; and color filter layers disposed between the first and second transistors and the first and second sub-pixel electrodes, the color filter layers including: a first color filter overlapping the first transistor and the first sub-pixel electrode, the first color filter representing a first color, and a first color filter pattern representing a second color different from the first color, the first color filter pattern overlapping the first transistor and the second transistor.

A first data line and a second data line may be configured to transmit different data voltages from each other for one image signal may be further included, the first transistor may include a first source electrode electrically connected to the first data line, the second transistor may include a second source electrode electrically connected to the second data line, and the first transistor and the second transistor may be disposed between the first data line and the second data line in a plan view.

A gate line electrically connected to the first transistor and the second transistor may be further included, the gate line may have a first opening overlapping the first source electrode and a second opening overlapping the second source electrode, and the first color filter pattern may not overlap the first opening and the second opening.

The color filter layers may further include a second color filter representing the second color same as the first color filter pattern, and the first color filter pattern may be separated from the second color filter.

A third transistor and a fourth transistor overlapping the second color filter may be further included.

The display device may further include a first data line electrically connected to a first source electrode included in the first transistor and a second data line electrically connected to a second source electrode included in the second transistor, and the first data line and the second data line may be configured to transmit data voltages for separate image signals.

The first color filter pattern may overlap the first data line and the second data line.

The color filter layers may further include a second color filter overlapping the second transistor and the second sub-pixel electrode and a third color filter representing the second color same as the first color filter pattern, the second color filter may represent a third color different from the first color filter pattern, and the first color filter pattern may be separated from the third color filter.

The display device may further include a third transistor and a fourth transistor overlapping the third color filter and a fifth transistor disposed between the second transistor and the fourth transistor in a plan view, and the color filter layers may further include a second color filter pattern connected to the third color filter and overlapping the fifth transistor.

The first color filter pattern may be disposed between the substrate and the first color filter.

The second color may be red.

According to one or more embodiments of the invention, a display device includes: a first pixel, a second pixel, and a third pixel that are sequentially adjacent in a first direction; a first data line and a second data line; and color filter layers including a first color filter, a second color filter, and a first color filter pattern, wherein the second pixel includes: a first transistor including a first source electrode electrically connected to the first data line; and a second transistor including a second source electrode electrically connected to the second data line, wherein the first color filter is disposed corresponding to the first pixel, wherein the second color filter is disposed corresponding to the second pixel, and wherein the first color filter pattern overlapping the first transistor and the second transistor, the first color filter pattern representing a different color from the second color filter.

The first color filter pattern may be separated from the first color filter.

A gate line electrically connected to the first transistor and the second transistor may be further included, the gate line may include a first opening overlapping the first source electrode, and a second opening overlapping the second source electrode, and the first color filter pattern may not overlap the first opening and the second opening.

A display device according to an exemplary embodiment includes: a first pixel, a second pixel, and a third pixel that are sequentially adjacent in a first direction; a first data line and a second data line; and color filter layers including a first color filter, a second color filter, and a first color filter pattern, wherein the third pixel includes a first transistor including a first source electrode electrically connected to the first data line, wherein the second pixel includes a second transistor including a second source electrode electrically connected to the second data line, wherein the first color filter is disposed corresponding to the first pixel, wherein the second color filter is disposed corresponding to the second pixel, and wherein the first color filter pattern overlapping the first transistor and the second transistor, the first color filter pattern representing a different color from the second color filter.

The first color filter pattern may be separated from the first color filter.

The first color filter pattern may overlap the first data line and the second data line.

The second pixel may further include a third transistor, and the color filter layers may further include a second color filter pattern connected to the first color filter and overlapping the third transistor.

The first color filter pattern and the second color filter pattern may represent a same color as the first color filter.

The second color filter may include a recess portion recessed to be concave in the first direction into the second pixel at a boundary between the second pixel and the third pixel, and the recess portion may overlap the first color filter pattern and further includes a light blocking part overlapping the recess portion.

It is to be understood that both the foregoing general description and the following detailed description are exemplary and explanatory and are intended to provide further explanation of the invention as claimed

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the inventive concepts.

FIG. 1 is a plan view of three adjacent pixels of a display device according to an exemplary embodiment.

FIG. 2 is a plan view of a part of three adjacent pixels of a display device according to an exemplary embodiment.

FIG. 3 is a cross-sectional view of the display device shown in FIG. 2 taken along a sectional line IIIa-IIIb.

FIG. 4 is a plan view of a part of three adjacent pixels of a display device according to an exemplary embodiment.

FIG. 5 is a cross-sectional view of the display device shown in FIG. 4 taken along a sectional line Va-Vb.

FIG. 6 and FIG. 7 are plan views of a part of three adjacent pixels of a display device according to an exemplary embodiment.

### DETAILED DESCRIPTION

In the following description, for the purposes of explanation, numerous specific details are set forth in order to provide a thorough understanding of various exemplary embodiments or implementations of the invention. As used herein “embodiments” and “implementations” are interchangeable words that are non-limiting examples of devices or methods employing one or more of the inventive concepts disclosed herein. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments. Further, various exemplary embodiments may be different, but do not have to be exclusive. For example, specific shapes, configurations, and characteristics of an exemplary embodiment may be used or implemented in another exemplary embodiment without departing from the inventive concepts.

Unless otherwise specified, the illustrated exemplary embodiments are to be understood as providing exemplary features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an exemplary embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the DR1-axis, the DR2-axis, and the DR3-axis are not limited to three axes of a rectangular coordinate system, such as the x, y, and z-axes, and may be interpreted in a broader sense. For example, the DR1-axis, the DR2-axis, and the DR3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., is rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various exemplary embodiments are described herein with reference to sectional illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

Throughout this specification and the claims which follow, a plan view means a view when observing a surface parallel to two directions (e.g., a direction DR1 and a direction DR2) crossing each other, and a cross-sectional view means a view when observing a surface cut in a direction (e.g., a direction DR3) perpendicular to the surface parallel to the direction DR1 and the direction DR2. Also, to overlap two constituent elements means that two constituent elements are overlapped in the direction DR3 (e.g., a direction perpendicular to an upper surface of the substrate) unless stated otherwise.

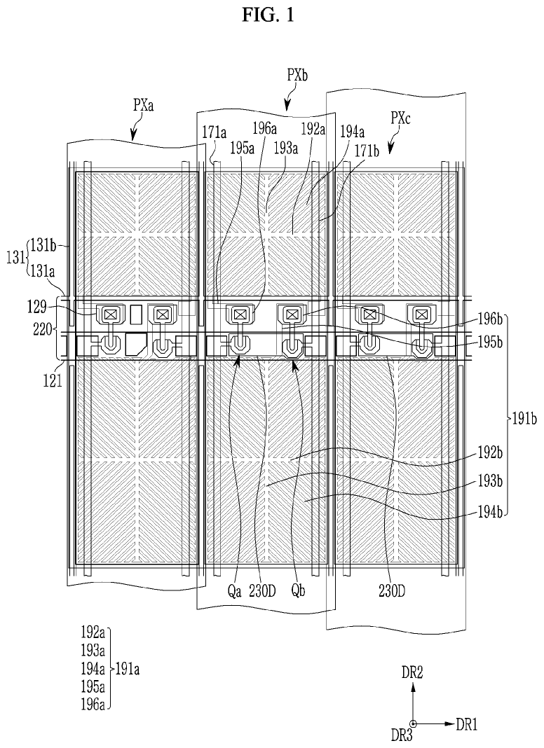

Now, a display device according to an exemplary embodiment is described with reference to FIGS. 1, 2, and 3.

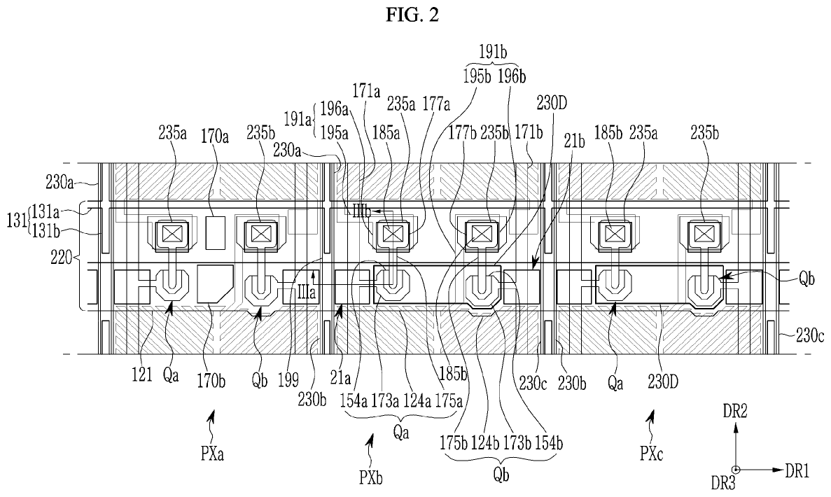

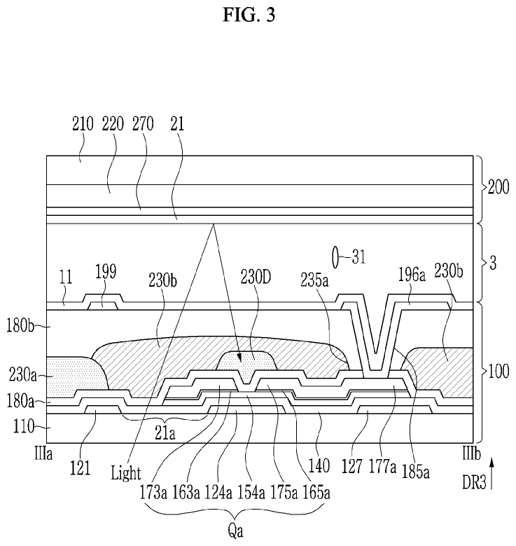

FIG. 1 is a plan view of three adjacent pixels of a display device according to an exemplary embodiment, FIG. 2 is a plan view of a part of three adjacent pixels of a display device according to an exemplary embodiment, and FIG. 3 is a cross-sectional view of the display device shown in FIG. 2 taken along a sectional line IIIa-IIIb.

The display device according to an exemplary embodiment as a liquid crystal display, as shown in FIG. 3, includes a first display panel 100 and a second display panel 200, and a liquid crystal layer 3 disposed between the two display panels 100 and 200 in a cross-sectional view.

The liquid crystal display includes a display area displaying an image in a plan view, and the display area includes a plurality of pixels PXa, PXb, and PXc. The pixels PXa, PXb, and PXc may be alternately arranged in a first direction DR1.

The first display panel 100 includes a gate conductive layer including a gate line 121, a storage electrode line 131, a dummy pattern 129, etc. disposed on a substrate 110 including an insulating material such as glass, plastic, etc.

The gate line 121 mainly extends in the first direction DR1 and may transmit a gate signal. The gate line 121 may include a first gate electrode 124a and a second gate electrode 124b in each of the pixels PXa, PXb, and PXc.

The gate line 121 may form or have openings 21a and 21b, with at least a part disposed between the second gate electrode 124b of one of pixels PXa, PXb, and PXc and the first gate electrode 124a of the pixels PXa, PXb, and PXc adjacent thereto. The opening 21a may be disposed adjacent to the first gate electrode 124a and the opening 21b may be disposed adjacent to the second gate electrode 124b.

The storage electrode line 131 may include a transverse part 131a extending substantially parallel to the gate line 121 and a longitudinal part 131b connected to the transverse part 131a. The longitudinal part 131b of the storage electrode line 131 may extend along a boundary between two adjacent pixels of PXa, PXb, and PXc.

The dummy pattern 129 may be disposed between the transverse part 131a of the storage electrode line 131 and the gate line 121 adjacent to each other, and a pair of dummy patterns 129 may be disposed in each of the pixels PXa, PXb, and PXc. Each dummy pattern 129 may have an island shape.

A gate insulating layer 140 is disposed on the gate conductive layer. The gate insulating layer 140 may include an insulating material such as a silicon nitride (SiNx), a silicon oxide (SiOx), a silicon oxynitride, etc.

A semiconductor layer including a first semiconductor 154a and a second semiconductor 154b is disposed on the gate insulating layer 140. The first semiconductor 154a may overlap the first gate electrode 124a, and the second semiconductor 154b may overlap the second gate electrode 124b.

The semiconductor layer may include an amorphous silicon, a polycrystalline silicon, a metal oxide, etc.

Ohmic contacts 163a and 165a may be disposed on the semiconductor layer. A pair of ohmic contacts 163a and 165a may be disposed on the first semiconductor 154a, and a pair of different ohmic contacts may be disposed on the second semiconductor 154b. The ohmic contacts may be preferably made of a material such as n+ hydrogenated amorphous silicon in which an n-type impurity such as phosphor is doped with a high density, or a silicide. The ohmic contacts 163a and 165a may be omitted.

A data conductive layer including a plurality of data lines including a first data line 171a and a second data line 171b, a plurality of first drain electrodes 175a, and a plurality of second drain electrodes 175b is disposed on the ohmic contacts 163a and 165a.

The first data line 171a and the second data line 171b transmit the data signal and mainly extend in the second direction DR2, thereby crossing the gate line 121 and the transverse part 131a of the storage electrode line 131.

The first data line 171a and the second data line 171b corresponding to each pixel PXa, PXb, and PXc may respectively transmit data voltages for representing different luminances for one image signal. For example, the data voltage transmitted by the second data line 171b for the image signal of one gray may be equal to or lower than the data voltage transmitted by the first data line 171a. The first and second data lines 171a and 171b disposed in each of the adjacent pixels PXa, PXb, and PXc may transmit data voltages for separate image signals.

The first data line 171a may include a first source electrode 173a overlapping the first gate electrode 124a, and the second data line 171b may include a second source electrode 173b overlapping the second gate electrode 124b.

The first drain electrode 175a and the second drain electrode 175b may include one end with a bar shape and an expansion 177a and 177b with a wide end, respectively. The expansions 177a and 177b of the first drain electrode 175a and the second drain electrode 175b may be disposed between the storage electrode line 131 and the gate line 121.

Each of the drain electrodes 175a and 175b may overlap the dummy pattern 129 of the gate conductive layer. The end of the bar shape of the first drain electrode 175a and the second drain electrode 175b may be partially enclosed by the first source electrode 173a and the second source electrode 173b, respectively.

The first gate electrode 124a, the first source electrode 173a, and the first drain electrode 175a form a first transistor Qa along with the first semiconductor 154a, and the second gate electrode 124b, the second source electrode 173b, and the second drain electrode 175b form a second transistor Qb along with the second semiconductor 154b. The channel of the first and second transistors Qa and Qb may be formed in the first semiconductor 154a disposed between the first source electrode 173a and the first drain electrode 175a facing each other and the second semiconductor 154b disposed between the second source electrode 173b and the second drain electrode 175b.

The first and second transistors Qa and Qb disposed in each of the pixels PXa, PXb, and PXc may be arranged in the direction that the gate line 121 extends, that is, the first direction DR1. Also, in a plan view, the first and second transistors Qa and Qb may be disposed between the first data line 171a and the second data line 171b corresponding to each pixel PXa, PXb, and PXc.

The first and second transistors Qa and Qb may function as switching elements transmitting the data voltage transmitted by the first and second data lines 171a and 171b according to the gate signal transmitted by the gate line 121.

Referring to FIG. 1 and FIG. 2, the region where the gate line 121, the transverse part 131a of the storage electrode line 131, and the first and second transistors Qa and Qb are disposed may be covered by a light blocking member 220. The light blocking member 220 may substantially extend in the first direction DR1 to form a light blocking region of each pixel PXa, PXb, and PXc.

A first insulating layer 180a is disposed on the data conductive layer. The first insulating layer 180a may include an organic insulating material or an inorganic insulating material.

Color filter layers including a plurality of color filters 230a, 230b, and 230c and a color filter pattern 230D may be disposed on the first insulating layer 180a.

Each color filter 230a, 230b, and 230c may display one among primary colors such as three primary colors of red, green, and blue, or four primary colors. The color filters 230a, 230b, and 230c are not limited to the three primary colors such as red, green, and blue, and primary colors such as cyan, magenta, yellow, and white may be displayed. For example, the color filter 230a may represent red, the color filter 230b may represent green, and the color filter 230c may represent blue.

The color filter 230a may be disposed corresponding to the pixel PXa, the color filter 230b may be disposed corresponding to the pixel PXb, and the color filter 230c may be disposed corresponding to the pixel PXc. Each of the color filters 230a, 230b, and 230c may extend in the second direction DR2 to correspond to a plurality of pixels disposed in one column. The color filters of one group including three color filters 230a, 230b, and 230c may be repeatedly disposed in the first direction DR1. That is, three color filters 230a, 230b, and 230c may be alternately disposed in the first direction DR1.

Two color filters of 230a, 230b, and 230c corresponding to two adjacent pixels of PXa, PXb, and PXc may overlap each other in the third direction DR3 at the boundary between two adjacent pixels of PXa, PXb, and PXc on the substrate 110. For example, the color filter 230a of the pixel PXa may overlap the color filter 230b of the pixel PXb adjacent thereto at the boundary between two adjacent pixels PXa and PXb. The overlapping part of two color filters 230a and 230b overlapping each other may overlap the longitudinal part 131b of the storage electrode line 131.

Two color filters of 230a, 230b, and 230c overlapping each other between two adjacent pixels of PXa, PXb, and PXc may have a light blocking function of preventing or reducing a light leakage between two adjacent pixels of PXa, PXb, and PXc.

Each of the color filters 230a, 230b, and 230c may include openings 235a and 235b respectively overlapping the expansions 177a and 177b of the first and second drain electrodes 175a and 175b.

The color filter pattern 230D may represent the same color, may be disposed on the same layer, may include the same material, and may be simultaneously formed in the same process as the color filter 230a. Particularly, the color filter pattern 230D may represent red.

The color filter pattern 230D is separated from the color filter 230a or the pixel PXa representing the same color as the color filter pattern 230D, and the color filter pattern 230D may be disposed one by one in the pixels PXb and PXc in which the color filters 230b and 230c represent the different color from the color filter 230a, respectively.

The color filter pattern 230D disposed in each pixel PXb and PXc overlaps the entirety of the first and second transistors Qa and Qb. Particularly, the color filter pattern 230D disposed in each pixel PXb and PXc may overlap all channels of the first and second semiconductors 154a and 154b of the first and second transistors Qa and Qb.

Accordingly, most of the light incident to the channel side of the first and second transistors Qa and Qb from above is absorbed in the color filter pattern 230D, thereby not reaching the first and second transistors Qa and Qb. Accordingly, an initial threshold voltage of the first and second transistors Qa and Qb is improved and a change amount of the threshold voltage may be reduced, and a color change of the display device may be reduced, thereby increasing reliability.

The color filter pattern 230D may be disposed between the color filters 230b and 230c and the first insulating layer 180a in a cross-sectional view. In a plan view, the color filter pattern 230D may be disposed in the region in which the light blocking member 220 is disposed. Also, each color filter pattern 230D may be disposed between the first data line 171a and the second data line 171b corresponding to one pixel of PXb and PXc.

The length of each color filter pattern 230D in the first direction DR1 may be longer than the length of the second direction DR2. The length of each color filter pattern 230D in the first direction DR1 may be larger than about 30 micrometers.

As above-described, as the color filter pattern 230D disposed in each pixel PXb and PXc and blocking the light incident to the transistor is formed of one plate pattern overlapping the entirety of the plurality of transistors Qa and Qb of each pixel PXb and PXc, compared with a case that each color filter pattern is formed in each of the transistors Qa and Qb, the size of the color filter pattern 230D may be expanded such that the uniformity of the size of the color filter pattern 230D may be effectively managed in the manufacturing process of the display device. Also, in each pixel PXb and PXc, since only one color filter pattern 230D is formed for the plurality of transistors Qa and Qb, a separation rate of the color filter pattern 230D may be lowered.

Dummy patterns 170a and 170b disposed in the data conductive layer may be disposed between the first transistor Qa and the second transistor Qb of the pixel PXa to which the color filter pattern 230D is not applied. However, in the pixels PXb and PXc where the color filter pattern 230D is disposed, the data conductive layer overlapping the color filter pattern 230D may only include the source electrodes 173a and 173b and the drain electrodes 175a and 175b of the first and second transistors Qa and Qb. Accordingly, the color filter pattern 230D may be prevented or restrained from abnormally rising upward in the pixels PXb and PXc.

The opening 21a of the gate line 121 may overlap a part of the first data line 171a and the first source electrode 173a, and the opening 21b of the gate line 121 may overlap a part of the second data line 171b and the second source electrode 173b. When a defect is generated in the pixel, the defect pixel may be repaired by irradiating a laser to the first source electrode 173a and/or the second source electrode 173b through the openings 21a and 21b to cut the first transistor Qa and/or the second transistor Qb from the first data line 171a and/or the second data line 171b.

Referring to FIGS. 1, 2, and 3, the color filter pattern 230D does not overlap the openings 21a and 21b. Accordingly, one color filter of 230a, 230b, and 230c is disposed on the openings 21a and 21b of each pixel PXa, PXb, and PXc, so a possibility that a display defect such as a black spot may be generated by the irradiation of the laser for two or more color filters is low during the repair of the defective pixel.

A second insulating layer 180b may be disposed on the color filters 230a, 230b, and 230c and the color filter pattern 230D. The second insulating layer 180b may include the inorganic insulating material or the organic insulating material, and may particularly include the organic insulating material, thereby forming an almost flat upper surface. As the second insulating layer 180b performs a roll as an overcoat for the color filter 230a, 230b, and 230c and the color filter pattern 230D, the color filters 230a, 230b, and 230c and the color filter pattern 230D may be prevented or restrained from being exposed and an impurity such as a pigment may be prevented or restrained from inflowing into the liquid crystal layer 3.

The first insulating layer 180a and the second insulating layer 180b have a contact hole 185a disposed on the expansion 177a of the first drain electrode 175a and a contact hole 185b disposed on the expansion 177b of the second drain electrode 175b. In a plan view, the contact holes 185a and 185b may be respectively disposed in the openings 235a and 235b of the color filters 230a, 230b, and 230c.

A pixel electrode layer including a pixel electrode including a plurality of first sub-pixel electrodes 191a and a plurality of second sub-pixel electrodes 191b and a shielding electrode 199 may be disposed on the second insulating layer 180b. The first sub-pixel electrode 191a may be disposed at one side and the second sub-pixel electrode 191b may be disposed at the other side based on the region where the first and second transistors Qa and Qb are disposed for each pixel PXa, PXb, and PXc.

Each entire shape of each of the first sub-pixel electrode 191a and the second sub-pixel electrode 191b may be quadrangular. The first sub-pixel electrode 191a may include a shaped stem including a transverse stem 192a and a longitudinal stem 193a, and a plurality of branches 194a extending from the cross-shaped stem to the outside. The second sub-pixel electrode 191b may include a cross-shaped stem including a transverse stem 192b and a longitudinal stem 193b, and a plurality of branches 194b extending from the cross-shaped stem to the outside.

The size of the first sub-pixel electrode 191a in a plan view may be smaller than the size of the second sub-pixel electrode 191b in a plan view.

The first sub-pixel electrode 191a may include an extending part 195a protruded toward the expansion 177a of the first drain electrode 175a and a contact portion 196a connected to the end of the extending part 195a, and the second sub-pixel electrode 191b may include an extending part 195b protruded toward the expansion 177b of the second drain electrode 175b and a contact portion 196b connected to the end of the extending part 195b. The contact portion 196a is electrically connected to the expansion 177a of the first drain electrode 175a through the contact hole 185a, and the contact portion 196b is electrically connected to the expansion 177b of the second drain electrode 175b through the contact hole 185b.

If the first transistor Qa and the second transistor Qb are turned on, the first sub-pixel electrode 191a and the second sub-pixel electrode 191b may receive the data voltage from the first drain electrode 175a and the second drain electrode 175b, respectively.

The shielding electrode 199 may include the transverse part extending in the first direction DR1 and/or the longitudinal part extending in the second direction DR2. The shielding electrode 199 extends between the pixels PXa, PXb, and PXc adjacent in the first direction DR1 and/or between the pixels PXa, PXb, and PXc adjacent in the second direction DR2, thereby preventing or reducing coupling and light leakage between the adjacent pixels PXa, PXb, and PXc. The longitudinal part of the shielding electrode 199 may overlap the longitudinal part 131b of the storage electrode line 131.

The pixel electrode layer may include a transparent conductive material such as indium-tin oxide (ITO), indium-zinc oxide (IZO), a metal thin film, etc.

The arrangement and the shape of the pixels PXa, PXb, and PXc, the structure of the transistor, and the shape of the pixel electrode, which are described in the present exemplary embodiment, are only one example, and numerous variations are possible.

Although not shown, a plurality of spacers may be disposed on the pixel electrode layer and the second insulating layer 180b. The spacers may be formed at the position overlapping the dummy patterns 170a and 170b.

An alignment layer 11 may be coated on the pixel electrode layer and the second insulating layer 180b. The alignment layer 11 may be a vertical alignment layer. The alignment layer 11 may be rubbed in at least one direction, or may be a photo-alignment layer including a photo-reactive material.

Next, in the second display panel 200, the light blocking member 220 may be disposed on a substrate 210 (under the substrate 210 in FIG. 3) including the insulating material such as glass, plastic, etc. As above-described, the light blocking member 220 includes a part extending in the first direction DR1, and may overlap the first and second transistors Qa and Qb included in the plurality of pixels PXa, PXb, and PXc. According to another exemplary embodiment, the light blocking member 220 may be disposed in the first display panel 100, not the second display panel 200.

A common electrode 270 may be disposed on the light blocking member 220 (under the light blocking member 220 in FIG. 3). The common electrode 270 may be formed as a one plate type on the entire surface of the substrate 210. That is, the common electrode 270 may be formed without a patterned part such as a slit, etc. The common electrode 270 may transmit a common voltage Vcom of a predetermined magnitude.

The common electrode 270 may include the transparent conductive material such as ITO, IZO, the metal thin film, etc.

An alignment layer 21 may be coated on the common electrode 270 (under the common electrode 270 in FIG. 3). The alignment layer 21 may be the vertical alignment layer. The alignment layer 21 may be rubbed in at least one direction, and may be the photo-alignment layer including the photo-reactive material.

The liquid crystal layer 3 includes a plurality of liquid crystal molecules 31. The liquid crystal molecules 31 may have negative dielectric anisotropy, and may be aligned substantially vertically with respect to the substrates 110 and 210 when no electric field is generated in the liquid crystal layer 3. The liquid crystal molecules 31 may be pretilted in predetermined directions when no electric field is generated in the liquid crystal layer 3. For example, the liquid crystal molecules 31 may be pretilted in the direction substantially parallel with the branches 194a and 194b of the first and second sub-pixel electrodes 191a and 191b.

A backlight supplying the light may be disposed on or at the rear of the first display panel 100. As shown in FIG. 3, when the light of the backlight passes between the gate conductive layer and the data conductive layer, is reflected from the common electrode 270 of the second display panel 200, and is again incident toward the first transistor Qa or the second transistor Qb of the first display panel 100, most of the light is absorbed in the color filter pattern 230D to not reach the first transistor Qa or the second transistor Qb, as above-described, so the reliability of the display device may be increased.

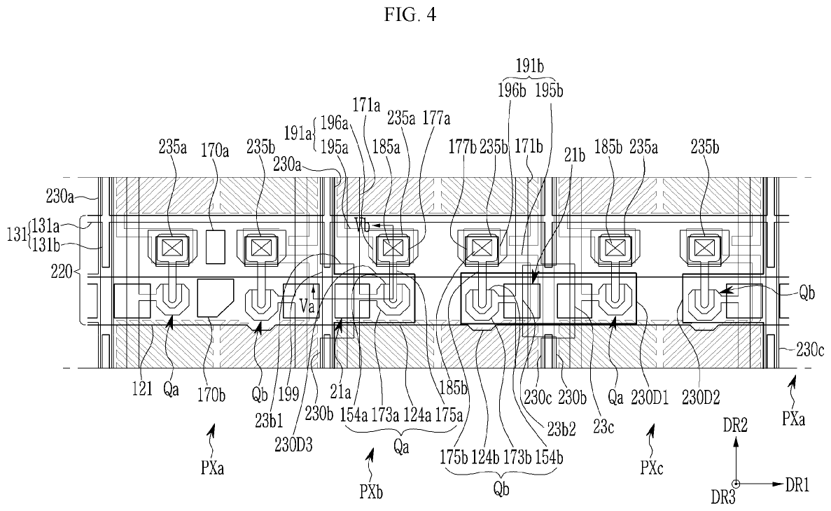

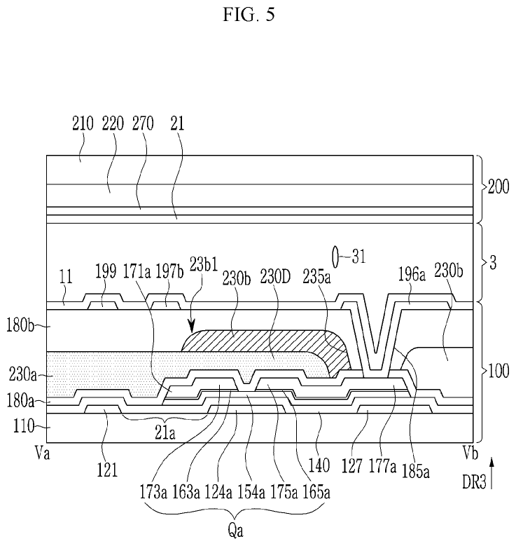

Next, the display device according to an exemplary embodiment is described with reference to FIG. 4 and FIG. 5 along with the above-described drawings.

FIG. 4 is a plan view of a part of three adjacent pixels of a display device according to an exemplary embodiment, and FIG. 5 is a cross-sectional view of the display device shown in FIG. 4 taken along a sectional line Va-Vb.

Referring to FIG. 4 and FIG. 5, the display device according to the present exemplary embodiment may be the same as the above-described display device shown in FIGS. 1, 2, and 3; however the structure of the plurality of color filters 230a, 230b, and 230c may be different, and structures of color filter patterns 230D1, 230D2, and 230D3 disposed on the same layer as the color filter pattern 230D may be different from the color filter pattern 230D.

The color filter pattern 230D1 disposed on the same layer and representing the same color as the color filter 230a corresponding to the pixel PXa may be separated from the color filter 230a or the pixel PXa, and may be continuously formed throughout two adjacent pixels PXb and PXc.

In detail, the color filter pattern 230D1 may overlap the entirety of the second transistor Qb disposed on the right of the pixel PXb and the first transistor Qa disposed on the left of the pixel PXc. Particularly, the color filter pattern 230D1 may overlap the entirety of the channels of the semiconductors 154a and 154b of the second transistor Qb disposed at the right of the pixel PXb and the first transistor Qa disposed at the left of the pixel PXc. The first transistor Qa and the second transistor Qb of two pixels PXb and PXc overlapping one color filter pattern 230D1 may be substantially arranged in the first direction DR1.

The color filter pattern 230D1 may overlap the second data line 171b electrically connected to the second transistor Qb disposed at the right of the pixel PXb and the first data line 171a electrically connected to the first transistor Qa disposed at the left of the pixel PXc.

The color filter pattern 230D2 disposed on the same layer and representing the same color as the color filter 230a is connected to the left part of the color filter 230a, and may overlap the second transistor Qb of the pixel PXc adjacent to the pixel PXa. Particularly, the color filter pattern 230D2 may overlap the channel of the second semiconductor 154b of the second transistor Qb of the pixel PXc.

The color filter pattern 230D3 disposed on the same layer and representing the same color as the color filter 230a is connected to the right part of the color filter 230a, and may overlap the first transistor Qa of the pixel PXb adjacent to the pixel PXa. Particularly, the color filter pattern 230D3 may overlap the channel of the first semiconductor 154a of the first transistor Qa of the pixel PXb.

That is, the color filter pattern 230D2 and the color filter pattern 230D3 may be patterns that are not separated from the color filter 230a and protrude from the color filter 230a. Accordingly, in three adjacent pixels PXa, PXb, and PXc, only one color filter pattern 230D1 may exist as the color filter pattern with the island shape separated from the color filter 230a. The length of the color filter pattern 230D1 in the first direction DR1 may be longer than the length in the second direction DR2, and the length of the color filter pattern 230D1 in the first direction DR1 may be larger than about 30 micrometers.

As above-described, since only one color filter pattern 230D1 exists as the pattern with the island shape for three adjacent pixels PXa, PXb, and PXc, the size of the color filter pattern 230D may extend compared with the case that each color filter pattern is formed in each of the transistors Qa and Qb, the uniformity of the size of the color filter pattern 230D may be effectively managed in the manufacturing process of the display device, and the separation rate of the color filter patterns 230D1, 230D2, and 230D3 may be reduced.

Like the above-described color filter pattern 230D, most of the light incident to the channel side of the first and second transistors Qa and Qb from above may be absorbed in the color filter patterns 230D1, 230D2, and 230D3 to not reach the first and second transistors Qa and Qb. Accordingly, the initial threshold voltage of the first and second transistors Qa and Qb is improved and the change amount of the threshold voltage may be reduced, and the color change of the display device may be reduced, thereby increasing reliability.

The color filter patterns 230D1, 230D2, and 230D3 may be disposed in the region where the light blocking member 220 is disposed.

At the boundary between two adjacent pixels PXb and PXc where the color filter pattern 230D1 is disposed, the color filter 230b may include a recess portion 23b2 recessed to be concave toward the inside of the pixel PXb, and the color filter 230c may include a recess portion 23c recessed to be concave toward the inside of the pixel PXc. The recess portion 23b2 and the recess portion 23c may overlap the color filter pattern 230D1.

Accordingly, the color filters 230b and 230c may not overlap each other at the boundary between two adjacent pixels PXb and PXc, where the color filter pattern 230D1 is disposed. That is, two adjacent color filters 230b and 230c overlap each other at the boundary that does not overlap the color filter pattern 230D1 among the boundary between two adjacent pixels PXb and PXc, and the color filter pattern 230D1 only exists at the boundary overlapping the color filter pattern 230D1 such that the step becoming abnormally high due to the overlapping of three color filter among the color filter layer or the color filter pattern between two adjacent pixels PXb and PXc may be prevented or reduced.

One of the recess portion 23b2 and the recess portion 23c shown in FIG. 4 may be omitted.

Referring to FIG. 4, at the boundary between two adjacent pixels PXa and PXb, the color filter 230b may further include a recess portion 23b1 recessed to be concave toward the inside of the pixel PXb. The recess portion 23b1 may overlap the color filter pattern 230D3. The recess portion 23b1 may be omitted.

Although not shown, at the boundary between two adjacent pixels PXc and PXa, the color filter 230c may further include the recess portion recessed to be concave toward the inside of the pixel PXc.

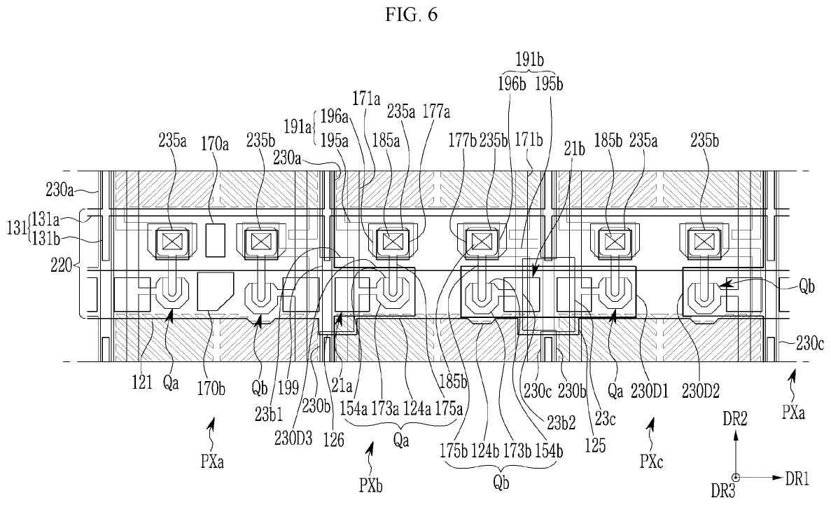

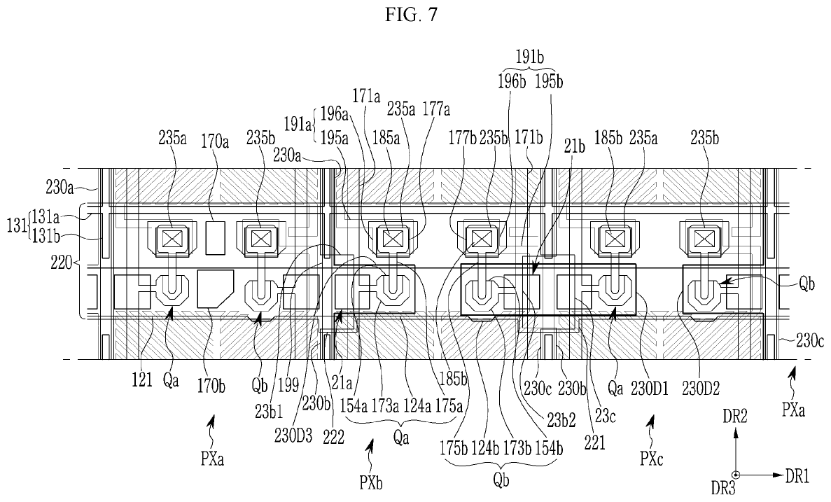

Next, the display device according to an exemplary embodiment is described with reference to FIG. 6 and FIG. 7 along with the above-described drawings.

FIG. 6 and FIG. 7 are plan views of a part of three adjacent pixels of a display device according to an exemplary embodiment.

First, referring to FIG. 6, the display device according to the present exemplary embodiment is the same as most of the display device shown in FIG. 4 and FIG. 5; however the gate line 121 may be different.

According to the present exemplary embodiment, the gate conductive layer may further include light blocking parts 125 and 126 overlapping the recess portions 23b1, 23b2, and 23c disposed at the region where the light blocking member 220 is not disposed. The light blocking parts 125 and 126 may be connected to the gate line 121.

At the boundary between the adjacent pixels PXa, PXb, and PXc, since two adjacent color filters 230a, 230b, and 230c do not overlap each other in the region where the recess portions 23b1, 23b2, and 23c are disposed, the light blocking effect is low, and particularly, the light may be leaked near the recess portions 23b1, 23b2, and 23c in the region where the light blocking member 220 is not disposed. However, according to the present exemplary embodiment, in the region where the light blocking member 220 is not disposed, the light leakage may be prevented or reduced by the light blocking parts 125 and 126 overlapping the recess portions 23b1, 23b2, and 23c.

Next, referring to FIG. 7, the display device according to the present exemplary embodiment is the same as most of the display device shown in FIG. 4 and FIG. 5; however the light blocking member 220 may be different.

According to the present exemplary embodiment, the light blocking member 220 may overlap the entire region of the recess portions 23b1, 23b2, and 23c. Particularly, the lower part of the recess portions 23b1, 23b2, and 23c formed under the gate line 121 may be covered by light blocking parts 221 and 222 included in the light blocking member 220.

According to the present exemplary embodiment, since the light blocking member 220 overlaps all regions of the recess portions 23b1, 23b2, and 23c, even if two adjacent color filters of 230a, 230b, and 230c are not overlapped with each other in the region where the recess portions 23b1, 23b2, and 23c are disposed at the boundary between the adjacent pixels of PXa, PXb, and PXc, the light leakage may be prevented or reduced.

The exemplary embodiments illustrate that the pixels PXa, PXb, and PXc of the display device include two transistors Qa and Qb, and it is such an implementation that has been mainly described. However, the exemplary embodiments are not limited thereto, and one of the pixels PXa, PXb, and PXc may include three or more transistors. In this case, the color filter pattern may have the size and the shape simultaneously overlapping two or more transistors in one pixel, or may have the size and the shape simultaneously overlapping two or more transistors of two or more adjacent pixels. Accordingly, the size uniformity of the color filter pattern preventing or restraining the light from inflowing to the transistor may be effectively managed and the size of the color filter pattern may be largely maintained, thereby the separation possibility of the color filter pattern may be lower and the manufacturing process of the display device may be easy.

According to the exemplary embodiments of the present disclosure, the threshold voltage change of the transistor may be reduced, the size uniformity of the pattern may be effectively managed, and a defect rate such as a separation of the pattern may be reduced.

Although certain exemplary embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. A display device comprising:
a substrate;
a first transistor and a second transistor disposed on the substrate;
a first sub-pixel electrode electrically connected to a first drain electrode of the first transistor;
a second sub-pixel electrode electrically connected to a second drain electrode of the second transistor; and
color filter layers disposed between the first and second transistors and the first and second sub-pixel electrodes, the color filter layers comprising:
a first color filter overlapping the first transistor and the first sub-pixel electrode, the first color filter representing a first color, and
a first color filter pattern representing a second color different from the first color, the first color filter pattern overlapping the first transistor and the second transistor.

2. The display device of claim 1, further comprising
a first data line and a second data line configured to transmit different data voltages from each other for one image signal,
wherein the first transistor includes a first source electrode electrically connected to the first data line,
wherein the second transistor includes a second source electrode electrically connected to the second data line, and
wherein the first transistor and the second transistor are disposed between the first data line and the second data line in a plan view.

3. The display device of claim 2, further comprising
a gate line electrically connected to the first transistor and the second transistor,
wherein the gate line has a first opening overlapping the first source electrode and a second opening overlapping the second source electrode, and
wherein the first color filter pattern does not overlap the first opening and the second opening.

4. The display device of claim 1, wherein the color filter layers further comprise a second color filter representing the second color same as the first color filter pattern, and
wherein the first color filter pattern is separated from the second color filter.

5. The display device of claim 4, further comprising
a third transistor and a fourth transistor overlapping the second color filter.

6. The display device of claim 1, further comprising:
a first data line electrically connected to a first source electrode included in the first transistor; and
a second data line electrically connected to a second source electrode included in the second transistor,
wherein the first data line and the second data line are configured to transmit data voltages for separate image signals.

7. The display device of claim 6, wherein
the first color filter pattern overlaps the first data line and the second data line.

8. The display device of claim 7, wherein
the color filter layers further comprise:
a second color filter overlapping the second transistor and the second sub-pixel electrode; and
a third color filter representing the second color same as the first color filter pattern,
wherein the second color filter represents a third color different from the first color filter pattern, and
wherein the first color filter pattern is separated from the third color filter.

9. The display device of claim 8, further comprising
a third transistor and a fourth transistor overlapping the third color filter and
a fifth transistor disposed between the second transistor and the fourth transistor in a plan view, and
the color filter layers further comprise a second color filter pattern connected to the third color filter and overlapping the fifth transistor.

10. The display device of claim 1, wherein
the first color filter pattern is disposed between the substrate and the first color filter.

11. The display device of claim 1, wherein the second color is red.

12. A display device comprising:
a first pixel, a second pixel, and a third pixel that are sequentially adjacent in a first direction;
a first data line and a second data line; and
color filter layers comprising a first color filter, a second color filter, and a first color filter pattern,
wherein the second pixel comprises:
a first transistor including a first source electrode electrically connected to the first data line; and
a second transistor including a second source electrode electrically connected to the second data line,
wherein the first color filter is disposed corresponding to the first pixel,
wherein the second color filter is disposed corresponding to the second pixel, and
wherein the first color filter pattern overlapping the first transistor and the second transistor, the first color filter pattern representing a different color from the second color filter.

13. The display device of claim 12, wherein the first color filter pattern is separated from the first color filter.

14. The display device of claim 13, further comprising a gate line electrically connected to the first transistor and the second transistor,
wherein the gate line includes a first opening overlapping the first source electrode, and a second opening overlapping the second source electrode, and
wherein the first color filter pattern does not overlap the first opening and the second opening.

15. A display device comprising:
a first pixel, a second pixel, and a third pixel that are sequentially adjacent in a first direction;
a first data line and a second data line; and
color filter layers comprising a first color filter, a second color filter, and a first color filter pattern,
wherein the third pixel comprises a first transistor including a first source electrode electrically connected to the first data line,
wherein the second pixel comprises a second transistor including a second source electrode electrically connected to the second data line,
wherein the first color filter is disposed corresponding to the first pixel,
wherein the second color filter is disposed corresponding to the second pixel, and
wherein the first color filter pattern overlapping the first transistor and the second transistor, the first color filter pattern representing a different color from the second color filter.

16. The display device of claim 15, wherein the first color filter pattern is separated from the first color filter.

17. The display device of claim 16, wherein the first color filter pattern overlaps the first data line and the second data line.

18. The display device of claim 17, wherein the second pixel further comprises a third transistor, and
wherein the color filter layers further comprise a second color filter pattern connected to the first color filter and overlapping the third transistor.

19. The display device of claim 18, wherein the first color filter pattern and the second color filter pattern represent a same color as the first color filter.

20. The display device of claim 15, wherein the second color filter includes a recess portion recessed to be concave in the first direction into the second pixel at a boundary between the second pixel and the third pixel, and
wherein the recess portion overlaps the first color filter pattern and further includes a light blocking part overlapping the recess portion of the second color filter.
